(19) United States
(12) Patent Application Publication
(10) Pub. No.: US 2006/0168631 A1
(43) Pub. Date: Jul. 27, 2006

(54) Method and apparatus for displaying content information

(75) Inventors: Yuko Nishikawa, La Jolla, CA (US); Michael A. Bergeron, Poway, CA (US)

Correspondence Address: CROWELL & MORING LLP;INTELLECTUAL PROPERTY GROUP, P.O. BOX 14300, WASHINGTON, DC, 20044-4300, US

(73) Assignees: Sony Corporation; Sony Electronics Inc.

(21) Appl. No.: 11/040,972

(22) Filed: Jan. 21, 2005

(51) Int. Cl. H04N 7/173; H04N 7/16

(52) U.S. Cl. 725/89; 725/134; 725/142

(57) ABSTRACT

Methods and apparatus for displaying content information. In one embodiment, content information is presented in a digital video recorder status bar. Such content information may be based on the electronic program guide (EPG) data provided by, for example, the broadcasters themselves. In another embodiment, the content information to be integrated with the DVR status bar may include, but not be limited to, the beginning of the DVR's live cache, the end of the last live cache, program transition and program titles in the live cache, program information for the next program to be broadcast on the same channel.

### FIELD OF THE INVENTION

This invention relates generally to the time-shifting of television and video programming and in particular to on-screen display of content information with video.

### BACKGROUND OF THE INVENTION

The Video Cassette Recorder (VCR) has changed the lives of television (TV) viewers by allowing viewers to time-shift TV programs to match their lifestyles. Using the VCR, the viewer stores programs onto magnetic tape; this can then be played back at the viewer's convenience. The VCR gives the viewer the ability to pause the program playback whenever he desires, fast-forward through unwanted program material or commercials, and to replay favorite scenes. However, a VCR cannot both capture and play back information at the same time.

The use of a digital computer system to solve this problem has been suggested. U.S. Pat. No. 5,317,551 issued to Logan et al., on Dec. 6, 1994, teaches a method for concurrent video recording and playback. It presents a microprocessor-controlled broadcast and playback device. However, the approach requires that the microprocessor and hard disk must be very fast in order to keep up with high video rates found in television transmission.

The use of a multimedia time-warping system to solve this problem has been suggested. U.S. Pat. No. 6,233,389 issued to Barton et al. on May 15, 2001 teaches such a system, which utilizes the approach that decouples the microprocessor from the high video data rates, thereby reducing the microprocessor and system requirements, which are at a premium. The common name employed in the art to describe such a multimedia time-warping system is Digital Video Recorder (DVR).

DVR systems typically include a live cache, refers to a temporary area of the hard disk drive (HDD) where live programming is being cached (i.e., temporarily placed), so that the cached program can be viewed again during the user's current viewing session. However, heretofore there has been no simple way for a user to easily and quickly determine what programming is currently in live cache, or what programming will be live cached in the future.

### SUMMARY OF THE INVENTION

Methods and apparatus for displaying program information in an on-screen status bar display. In one embodiment, a method includes caching video content received from a broadcast content source, displaying the cached video content on a display device, receiving a request to display a cache status bar, and collecting program information for the cached video content from the broadcast content source. The method further includes incorporating the program information into the cache status bar, and displaying the cache status bar with the program information on the display device.

Other aspects, features, and techniques of the invention will be apparent to one skilled in the relevant art in view of the following detailed description of the invention.

### BRIEF DESCRIPTION OF THE DRAWINGS

FIG. 1 depicts an embodiment of a system capable of implementing one or more aspects of the invention;

FIG. 2 depicts another embodiment of a system capable of implementing one or more aspects of the invention;

FIG. 3 depicts yet another embodiment of a system capable of implementing one or more aspects of the invention;

FIG. 4 depicts still another embodiment of a system capable of implementing one or more aspects of the invention;

FIG. 5 depicts a flow diagram illustrating one embodiment of a process by which content information may be displayed, consistent with the principles of the present invention;

FIG. 6 depicts one embodiment of a screen consistent with the principles of the invention; and

FIG. 7 depicts another embodiment of a screen consistent with the principles of the invention.

### DETAILED DESCRIPTION OF THE EXEMPLARY EMBODIMENTS

One aspect of the invention is to display information on a display device (e.g., television) relating to the nature of the video content presently being displayed and/or that which is being stored in the live cache of a companion Digital Video Recorder (DVR) system attached to the display device. In one embodiment, the invention may be housed in a set-top box which provides a video signal to a display device for presentation of video content. In addition, the set-top box device may be a DVR system, or may be coupled to a separate DVR system.

Another aspect of the invention is to provide content information in a DVR status bar. In one embodiment, this content information may be based on the electronic program guide (EPG) data provided by, for example, the broadcasters themselves. In one embodiment, the content information to be integrated with the DVR status bar may include, but not be limited to, the beginning of the DVR's live cache, the end of the last live cache, program transition and program titles in the live cache, program information for the next program to be broadcast on the same channel.

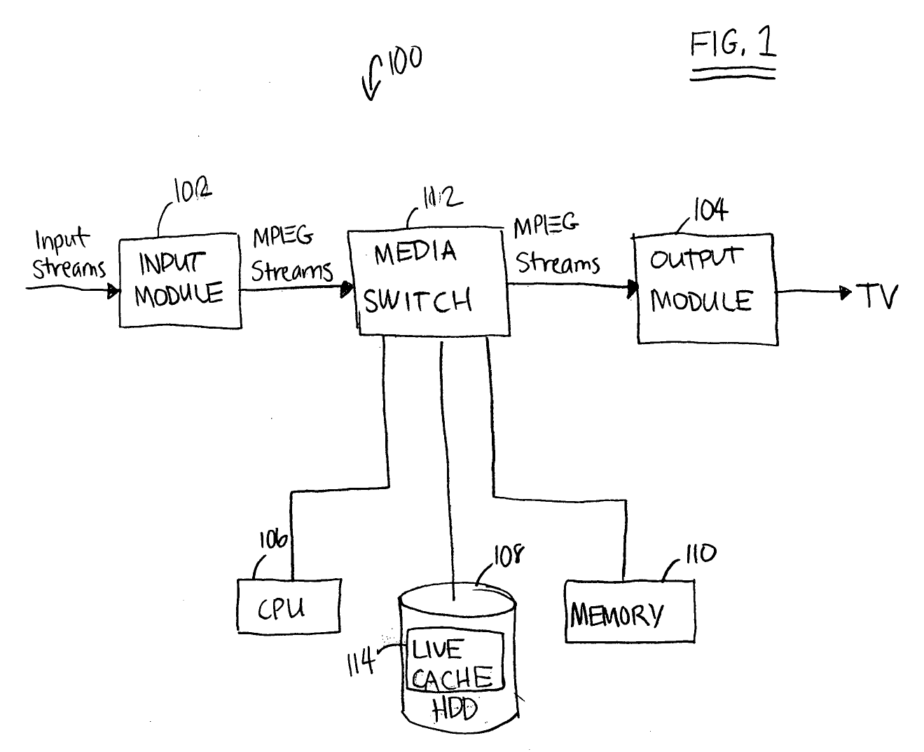

Referring now to the drawings, FIG. 1 illustrates an embodiment of a DVR system 100 capable of implementing one or more aspects of the invention. In the embodiment of FIG. 1, the system 100 includes an input module 102, a media switch 112, and an output module 104. In one embodiment, the input module 102 may accept video input streams in a multitude of forms (e.g., National Television Standards Committee (NTSC), PAL, Digital Satellite System (DSS), Digital Broadcast System (DBS), Advanced Television Standards Committee (ATSC), etc.). DBS, DSS, and ATSC are based on standards called Moving Pictures Experts Group 2 (MPEG2) and MPEG2 Transport. MPEG2 Transport is a standard for formatting the digital data stream from the source transmitter so that a receiver can disassemble the input stream to find programs in the multiplexed signal.

The input module 102 may produce MPEG streams. An MPEG2 transport multiplex supports multiple programs in the same broadcast channel, with multiple video and audio feeds and private data. The input module 102 may also be used to tune the channel to a particular program, extract a specific MPEG program out of it, and feed it into the rest of the system. Analog video signals may be encoded into a similar MPEG format using separate video and audio encoders, such that the remainder of the system is unaware of how the signal was obtained. Information may be modulated into the Vertical Blanking Interval (VBI) of the analog video signal in a number of standard ways. For example, the North American Broadcast Teletext Standard (NABTS) may be used to modulate information onto lines 10 through 20 of an NTSC signal, while the FCC mandates the use of line 21 for Closed Caption (CC) and Extended Data Services (EDS). Such signals may be decoded by the input module 102 and passed to the other modules as if they were delivered via a MPEG2 private data channel.

In one embodiment, the media switch 112 mediates between a microprocessor CPU 106, hard disk or other storage device 108, which may or may not include the DVR system's live cache 114, and volatile memory 110. Input streams are converted to an MPEG stream and sent to the media switch 112. The media switch 112 buffers the MPEG stream into memory. If the user is watching real time broadcast content, the media switch 112 may send the stream to the output module 104, as well as simultaneously write it to the hard disk or storage device 108.

The output module 104 may take the MPEG streams as input and produces an analog video signal according to a particular standard (e.g., NTSC, PAL, or other video standard). In one embodiment, the output module 104 contains an MPEG decoder, on-screen display (OSD) generator, analog video encoder and audio logic. The OSD generator may be used to supply images which will be overlaid on top of the resulting analog video signal. Additionally, the output module 104 can modulate information supplied by the program logic onto the VBI of the output signal in a number of standard formats, including NABTS, CC, and EDS.

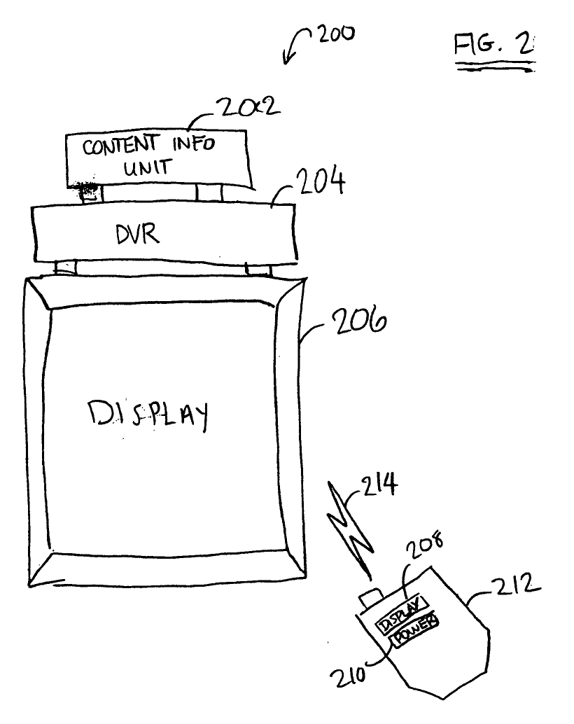

With respect to FIG. 2, which depicts one embodiment of a system 200 which implements one or more aspects of the invention as a set-top box (shown as the Content Info Unit 202). In this embodiment, the Content Info Unit 202 is in communication with a DVR 204. The ensemble of the Content Info Unit 202 and the DVR 204 collectively may be coupled to a display device, such as display 206. In one embodiment, the user may interact with the Content Info Unit 202 by means of control instructions sent by pressing buttons on the wireless remote 212. The user may press the display button 208 to input a control instruction 214 to the Content Info Unit 202 to begin displaying information, in a status bar at the bottom of the screen of the TV set 206, about the programming being displayed on display device 206. In another embodiment, the remote control 212 may include a power key 210 to power the Content Info Unit 204 on or off. It should equally be appreciated that a user may provide instructions to the control info unit 202 using any other known user input means. Moreover, wireless remote 212 may have additional or fewer input options than those depicted.

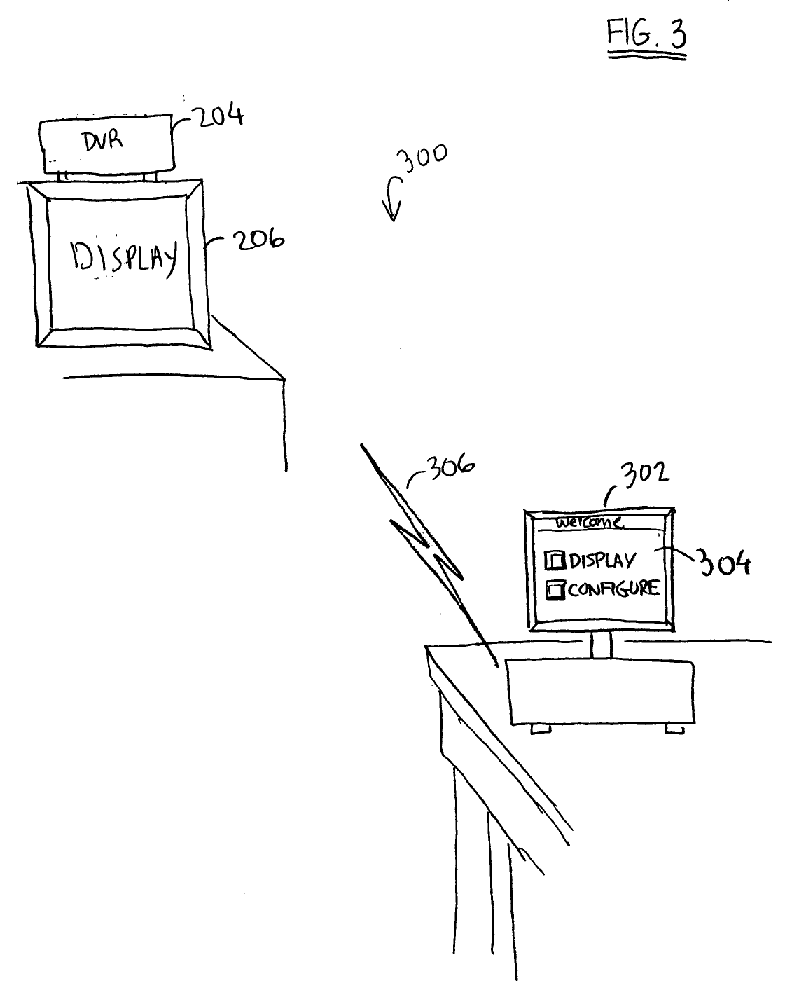

FIG. 3 depicts another embodiment of a system 300 capable of implementing one or more aspects of the invention. In this system 300, a dedicated device 302 with a touch-screen 304 with display and configure options. Upon selection of the appropriate option by touching the screen 304, a control instruction 306 may be sent to the DVR 204 residing, e.g., atop the display 206 to carry out the functions described above.

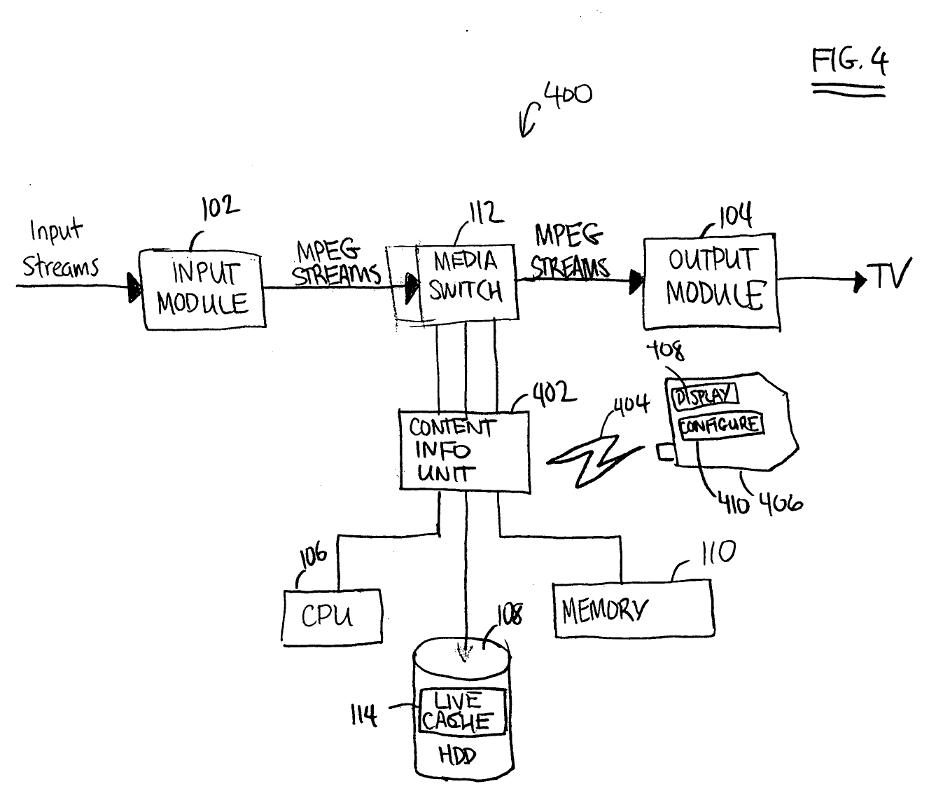

FIG. 4 depicts yet another embodiment of a system 400 capable of carrying out one or more aspects of the invention. In this embodiment, a content info unit 402 is integrated into a DVR-type configuration. The function of the DVR is as described above save for the addition of the Content Info Unit component 402 between the media switch 112 and the CPU 106, the hard disk or other storage device 108, which may contain the system's live cache 114, or the volatile memory 110. From here, the content info unit 402 may directly alter the MPEG data used by the DVR system internally in order to insert the programming information to be displayed on a status bar on-screen directly into the MPEG data stream(s). The user may input control instructions for displaying programming information via button 408 on the remote control 406, and for configuration via the button 410. It should equally be appreciated that a user may provide instructions to the control info unit 402 using any other known user input means. Moreover, remote control 406 may have additional or fewer input options.

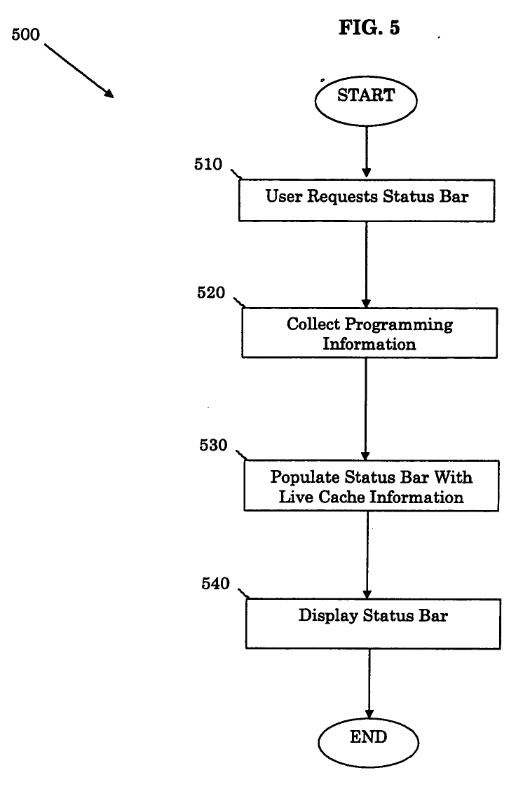

With respect to FIG. 5, one embodiment of a process 500 is depicted for displaying programming information on-screen at a user's request. When process 500 starts, the process starts with block 510, wherein the user inputs a control instruction to display the DVR status bar. In one embodiment, the DVR status bar may be displayed i) when any of the DVR-related remote control keys is pressed, at the beginning of playback, at the end of playback, and/or when a new chapter is placed by the user.

In response to the control instruction to display the DVR status bar, process 500 continues to block 520 where programming information (e.g., actors' names, show name, time/date, etc.) may be collected. In one embodiment, programming information may be retrieved from the EPG. In another embodiment, programming information is provided by the broadcasters themselves, such as in the VBI of the video content being broadcast to the user. The OTA EPG data for digital stations may be provided by the broadcasters via PSIP (Program and System Information Protocol). PSIP tables may be incorporated in the broadcaster transport stream (please note that not all broadcaster provide this data). PSIP also provides virtual channel mapping.

In one embodiment, the programming information relates to video content that has been stored on a DVR-type system. In another embodiment, the programming information to be retrieved may relate to the live cached content and/or the video content to be live cached. As previously mentioned, live cache refers to a temporary area of storage where live programming may be temporarily placed so that the cached program can be viewed again during the user's current viewing session. In one embodiment, the live cache is a fixed size, with a default time of 30 minutes and user configurable up to 90 minutes. Moreover, more than one program can be stored in live cache, up to the limit of the cache size.

Some of the functionality afforded by the live cache is to enable the user to reverse until the beginning of the cache or until the cache runs out, to forward through the cache until live programming is reached, to replay until the beginning point of the cache, to slow reverse or forward through the cache, to skip to any chapter mark placed in a current location in cache, and to pause the cached video content.

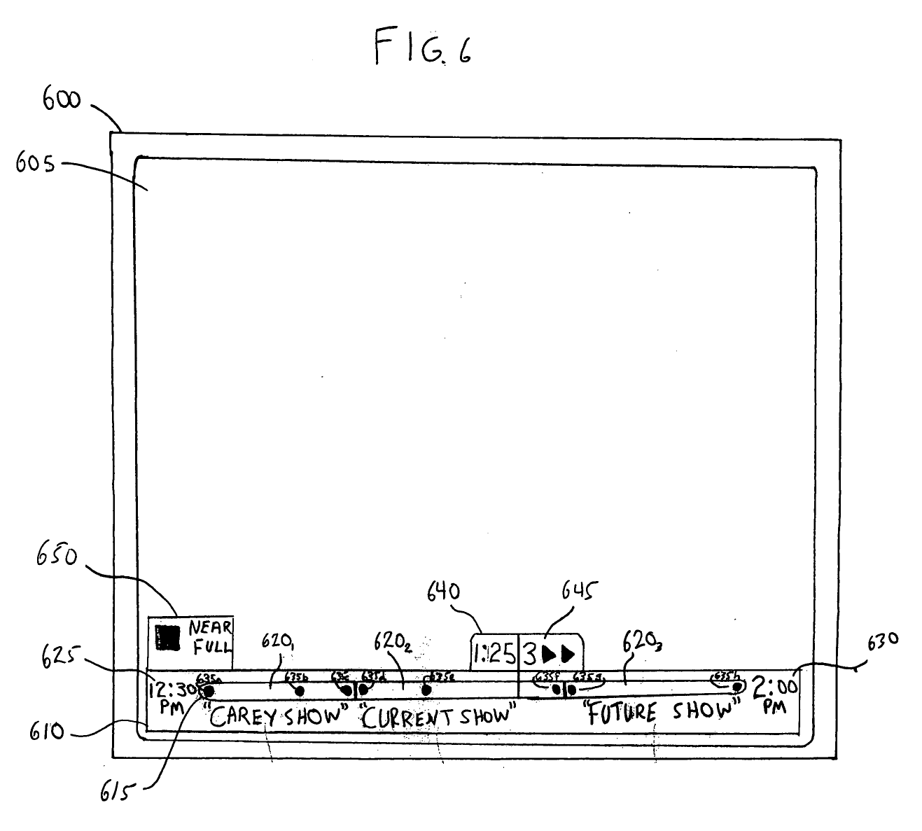

Process 500 then continues to box 530, wherein the retrieved/collected programming information is used to populate the status bar. Details of exemplary status bars are described below with reference to FIGS. 6-8. Process 500 then continues to block 540 where the status bar may then be presented on-screen to the user. Although in one embodiment the status bar is displayed as an overlay onto the video content being viewed, numerous other configurations may similarly be used for presenting the status bar to the user.

Referring now to FIG. 6, depicted is one embodiment of a screen 605 containing video content (not shown) that is being displayed on a display device 600. In this embodiment, status bar 610 is being overlaid on the screen 605 of the video content, which may be comprised of stored, cached or live video content.

Status bar includes a progress bar 615 which is a graphical representation of the cached video content. In one embodiment, the progress bar 615 may be divided into one or more segments 620₁-620₃, where each segment denotes a individual cached program. It should further be appreciated that the program cache may be of a fixed size (e.g., 30 minutes) and/or may be user configurable. In the embodiment of FIG. 6, the live cache is a 90 minute cache and may contain any number of programs up to the limit of the cache size.

Continuing to refer to FIG. 6, the status bar 610 is displayed near the bottom of the screen 605 further indicates the beginning of live cache in hours and minutes, as denoted by cache start time 625. Similarly, the end of the last segment (i.e., segment 6203) is denoted by cache end time 630.

As shown in FIG. 6, chapter marks 635ₐ-635ₕ may optionally be used to denote the beginning and ending of each segment/program. For example, each segment 620₁-620₃, is shown as including a beginning mark and an end mark. In addition, a user may be provided with the ability to place chapter marks (i.e., marks 635_{b} and 635ₑ) in live cache or in the recorded contents at points other than segment transitions. In one embodiment, chapter marks may be used to quickly jump to a particular point in the live cache by, for example, pressing a “Next” or “Previous” button on a user input device.

Status bar 610 is also depicted with optional play status box 640. In one embodiment, play status box 640 may be used to show the current position in the live cache. In this embodiment, the user is currently viewing video content from the second segment 620₂ at the 1 hour and 25 minute point. In addition, the play status box may optionally indicate the current trick play status 645. In this embodiment, the user is fast forwarding through live cache at 3 times the normal pace. Numerous other icons may be used to denote the following trick play conditions: Play, FF, REW, Slow, Slow Reverse, Stop, Pause, Advance, Previous and Next, Frame-by-Frame Forward and Reverse.

Status bar 610 is further depicted as including program title information below the progress bar 615 for the various programs stored in cache. In particular, the first cached program is cached in segment 620₁ (i.e., “Carey Show”), the second cached program is cached in segment 620₂ (i.e., “Current Show”), while the last cached program is cached in segment 620₃ (i.e., “Future Show”). In one embodiment, the programming information for the “Current Show” relates to the program currently being viewed, while the programming information for the “Future Show” may relate to programs stored at a later point in cache or to programs which are to be broadcasted at some future point and, therefore, are expected to be cached. While each segment includes only a program title, it should be appreciated that other programming information may similarly be incorporated into the status bar 610 (e.g., actors' names, program title, time/date, program summary, etc.). Moreover, the status bar 610 of FIG. 6 may further include an optional storage status box which indicates the current amount of storage available.

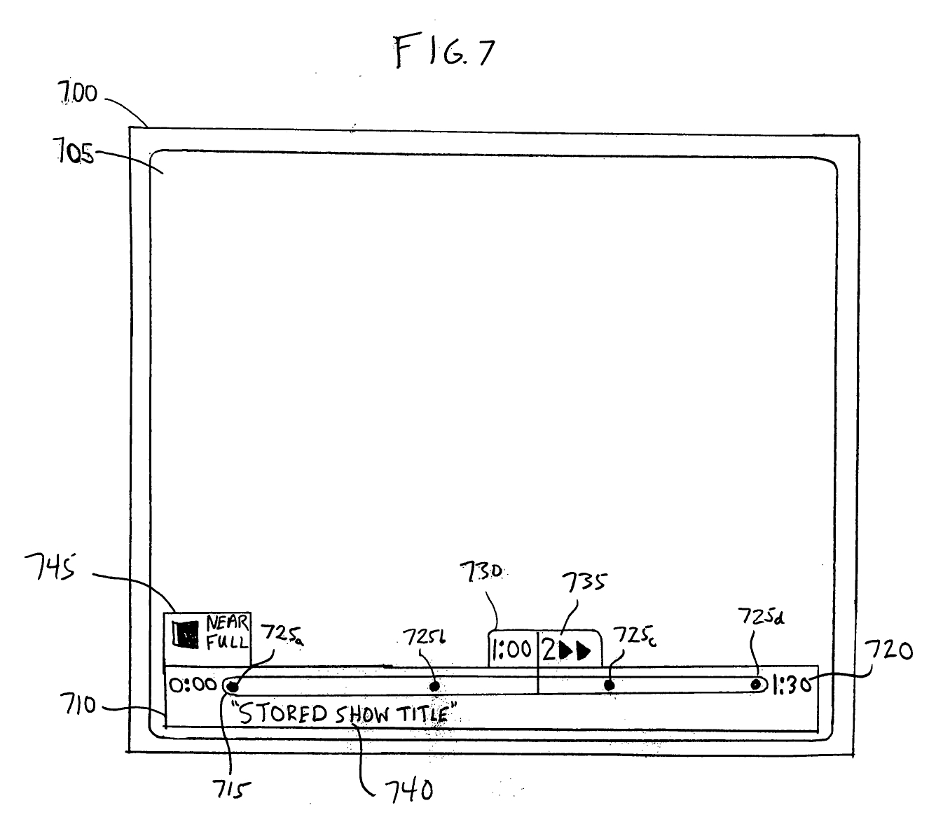

Referring now to FIG. 7, depicted is one embodiment of a screen 705 containing video content (not shown) that is being displayed on a display device 700. In this embodiment, the status bar 710 is being overlaid on the screen 705 of the video content, which is comprised of stored video content.

The status bar 710 includes a progress bar 715 which is a graphical representation of the stored video content (e.g., a broadcasted program). The status bar 710 is displayed near the bottom of the screen 705 further indicates the beginning of the stored video content as 0:00. The end of the stored video content is denoted by end time 720.

As shown in FIG. 7, chapter marks 725ₐ-725_{d} may optionally be used to denote the beginning and ending of the video content, as well as any user-placed chapter marks. As previously mentioned, chapter marks may be used to quickly take a viewer to a particular point in a program. Status bar 710 is also depicted with optional play status box 730. In one embodiment, play status box 730 may be used to show the current viewing position in the stored program. In this embodiment, the user is currently at exactly one hour into the 1½ program. In addition, the play status box may optionally indicate the current trick play status 735. In this embodiment, the user is fast forwarding through the program at 2 times the normal pace. Numerous other icons may be used to denote the following trick play conditions: Play, FF, REW, Slow, Slow Reverse, Stop, Pause, Advance, Previous and Next, Frame-by-Frame Forward and Reverse.

Status bar 710 is further depicted as including program title information 740 for the stored video content. While only a program title is depicted in FIG. 7, it should be appreciated that other programming information may similarly be incorporated into the status bar 710. Moreover, the status bar 710 of FIG. 7 may further include an optional storage status box 745 which indicates the remaining amount of video content storage.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for displaying content information comprising:
caching video content received from a broadcast content source;
displaying said cached video content on a display device;
receiving a request to display a cache status bar;
collecting program information for said cached video content from said broadcast content source;
incorporating said program information into said cache status bar; and
displaying said cache status bar with said program information on said display device.

2. The method of claim 1, wherein caching the video content comprises storing said video content in a volatile memory of a set-top box device which is coupled to said display device.

3. The method of claim 1, wherein receiving the request comprises receiving an instruction from a user input device to display the cache status bar, wherein said cache status bar is to indicate a current position within a program cache.

4. The method of claim 1, wherein collecting program information comprises collecting program information for said cached video content, and wherein said cached video content includes a plurality of broadcasted programs and said program information includes at least one of program titles and program lengths for said plurality of broadcasted programs.

5. The method of claim 4, wherein said program information further includes future programming information.

6. The method of claim 4, wherein said cache status bar is further to include a plurality of chapter marks indicating start and end points for said plurality of broadcasted programs.

7. The method of claim 1, wherein said cache status bar further includes storage information indicating an amount of remaining content storage.

8. The method of claim 1, wherein displaying said cache status bar comprises displaying said cache status bar with said program information on said display device as an overlay to said cached video content.

9. The method of claim 1, further comprising:
storing video content received from said broadcast content source in a non-volatile memory;
receiving a request to display said stored video content on the display device;
receiving a request to display a stored content status bar;
incorporating stored program information for said stored video content into said stored content status bar; and
displaying said stored content status bar with said stored program information on said display device.

10. An apparatus in communication with a display device, the apparatus comprising:
a memory containing one or more instruction sequences; and
a processor coupled to said memory, said processor to execute the one or more instructions to,
receive a request to display a cache status bar which indicates a current viewing position within a cache of video content.
collect program information for said cached video content from a broadcast content source,
incorporate said program information into said cache status bar, and
display said cache status bar with said program information on said display device.

11. The apparatus of claim 10, wherein said cached video content includes a plurality of broadcasted programs, and wherein said program information includes at least one of program titles and program lengths for said plurality of broadcasted programs.

12. The apparatus of claim 11, wherein said program information further includes future programming information.

13. The apparatus of claim 11, wherein said cache status bar is further to include a plurality of chapter marks indicating start and end points for said plurality of broadcasted programs.

14. The apparatus of claim 10, wherein said cache status bar further includes storage information indicating an amount of remaining content storage.

15. The apparatus of claim 10, wherein displaying said cache status bar comprises displaying said cache status bar with said program information on said display device as an overlay to said cached video content.

16. The apparatus of claim 10, wherein said processor is to execute said one or more instructions to further,
store video content received from said broadcast content source in a non-volatile memory,
receive a request to display said stored video content on the display device,
receive a request to display a stored content status bar,
incorporate stored program information for said stored video content into said stored content status bar, and
display said stored content status bar with said stored program information on said display device.

17. A computer program product comprising:
a computer usable medium having computer program code embodied therein to display information, the computer program product having:
computer readable program code to cache video content received from a broadcast content source;
computer readable program code to display said cached video content on a display device;
computer readable program code to receive a request to display a cache status bar;
computer readable program code to collect program information for said cached video content from said broadcast content source;
computer readable program code to incorporate said program information into said cache status bar; and
computer readable program code to display said cache status bar with said program information on said display device.

18. The computer program product of claim 17, wherein said computer readable program code to cache video content comprises computer readable program code to store said video content in a volatile memory of a set-top box device which is coupled to said display device.

19. The computer program product of claim 17, wherein said computer readable program code to receive the request comprises computer readable program code to receive an instruction from a user input device to display the cache status bar, wherein said cache status bar is to indicate a current position within a program cache.

20. The computer program product of claim 17, wherein said computer readable program code to collect program information comprises computer readable program code to collect program information for said cached video content, and wherein said cached video content includes a plurality of broadcasted programs and said program information includes at least one of program titles and program lengths for said plurality of broadcasted programs.

21. The computer program product of claim 20, wherein said program information further includes future programming information.

22. The computer program product of claim 20, wherein said cache status bar is further to include a plurality of chapter marks indicating start and end points for said plurality of broadcasted programs.

23. The computer program product of claim 17, wherein said cache status bar further includes storage information indicating an amount of remaining content storage.

24. The computer program product of claim 17, wherein said computer readable program code to display said cache status bar comprises computer readable program code to display said cache status bar with said program information on said display device as an overlay to said cached video content.

25. The computer program product of claim 17, further comprising:
computer readable program code to store video content received from said broadcast content source in a non-volatile memory;
computer readable program code to receive a request to display said stored video content on the display device;
computer readable program code to receive a request to display a stored content status bar;
computer readable program code to incorporate stored program information for said stored video content into said stored content status bar; and
computer readable program code to display said stored content status bar with said stored program information on said display device.
